(19) United States
(12) Patent Application Publication
(10) Pub. No.: US 2018/0215940 A1
(43) Pub. Date: Aug. 2, 2018

(54) NANOPLATELET DISPERSIONS, METHODS FOR THEIR PRODUCTION AND USES THEREOF

(71) Applicants: CAMBRIDGE ENTERPRISE LIMITED, Cambridge, Cambrigeshire (GB); NOVALIA LIMITED, Cambridge, Cambrigeshire (GB)

(72) Inventors: Guohua HU, Cambridge, Cambridgeshire, (GB); Richard Colin Thomson HOWE, Cambridge, Cambridgeshire (GB); Zongyin YANG, Cambridge, Cambridgeshire (GB); Leonard NG WEI TAT, Cambridge, Cambridgeshire (GB); Christopher Gareth JONES, Cambridge, Cambridgeshire (GB); Kate Jessie STONE, Cambridge, Cambridgeshire (GB); Tawfique HASAN, Cambridge, Cambridgeshire (GB)

(21) Appl. No.: 15/746,244

(22) PCT Filed: Jul. 22, 2016
(86) PCT No.: PCT/EP2016/067599

§ 371 Date: Jan. 19, 2018

(30) Foreign Application Priority Data
Jul. 22, 2015 (GB) 1512946.3

(51) Int. Cl. C09D 11/52; C01B 32/194; C09D 11/037; C09D 11/033; C09D 11/106; C08K 3/04; C08K 7/00; C01G 39/06; C01B 21/064; C09J 129/04

(52) U.S. Cl. CPC C09D 11/52; C01B 32/194; C09D 11/037; C09D 11/033; C09D 11/106; C08K 3/042; B82Y 40/00; C01G 39/06; C01B 21/0648; C09J 129/04; C01P 2006/40; C08K 2201/011; C08K 2201/001; C08K 7/00

(57) ABSTRACT

A dispersion of nanoplatelets or particles suspended in a carrier liquid is disclosed. The nanoplatelets or particles, e.g. graphene nanoplatelets, are derived from a layered material. The loading amount of nanoplatelets or particles in the dispersion is at least 20 mg nanoplatelets or particles per 1 ml of dispersion. The dispersion optionally further including a dispersant, the volume ratio of dispersant to the nanoplatelets or particles being less than 1:1. A process for manufacturing the dispersion includes mixing the carrier liquid and the nanoplatelets or particles under high shear conditions. The dispersion can be used as an ink system, as a functional additive within an ink, coating or adhesive formulation, and/or in the manufacture of a nanoplatelet-polymer composite or a particle-polymer composite.

### BACKGROUND TO THE INVENTION

### Field of the Invention

The present invention relates to nanoplatelet dispersions, methods for the production of nanoplatelet dispersions and uses of such dispersions. The invention has particularly, but not necessarily exclusive, application to dispersions of graphene nanoplatelets. The term “dispersions” includes pre-dispersions, pre-dispersions being dispersions which are intended to be added to other components, such as ink systems, coating systems, adhesive formulations or polymer formulations.

### Related Art

Carbon materials, such as carbon black, graphite, carbon nanotubes (CNTs), etc., are widely used as the conducting elements in conducting ink systems for printed electronics [1], and as fillers to composite systems to enhance their electrical, thermal or mechanical properties [2]-[4]. However, each type of carbon has disadvantages. Carbon black is not conductive enough for conducting inks for many applications, and thus requires the use of additional printing of grids or boundaries of other conducting inks (such as silver inks) [5]. Graphite particles, meanwhile, are usually too large to be useful for printing or coating techniques such as inkjet printing [5]. Meanwhile, both carbon black and graphite usually require a high loading in inks and composites (typically >20 wt. %) to achieve reasonable performances such as electrical conductivity. The high loading of fillers can degrade mechanical properties of printed inks and composites, such as strength, stiffness etc. Though CNTs produce relatively high conductivity for ink applications and enhance performances such as electrical conductivity and thermal conductivity of the composites while working as nano-fillers, their practical industrial applications in inks and composites are hindered by high production costs and low yields.

Graphene is another allotrope of carbon where atoms are covalently bonded in plane and stacked out of plane by van der Waals forces. With outstanding electrical, optical and mechanical properties, graphene produced by low yield methods has been emerging as a promising material for future applications and has been widely demonstrated in functional inks [6], [7], [8] and composites [9]. Various types of methods achieving mass production of chemically functionalized/unfunctionalized GNPs have been proposed aiming at low production cost and industrial manufacture [10]-[16]. There are now GNPs from many sources available in the market, for potential practical applications of graphene. However, applying GNPs in functional inks and composites remains challenging.

### SUMMARY OF THE INVENTION

State of the art strategies relating to formulation of GNP functional inks in large quantities require mass production of GNPs and suitable solvents, and may require dispersants [5], [17], such as suitable surfactants and polymers. This leads to several key challenges:
(1) GNP functional inks are typically formulated from a specific GNP type. It is often not clear whether these proposed ink formulation strategies are suitable for other types of GNPs, including the GNPs available in the market. When targeting industrial manufacture, it would be preferable to have a universal GNP functional ink formulation strategy applicable to a wide range of commercially available GNPs.
(2) Previous studies into solution processing of GNPs reveal that suitable solvents are usually expensive, aggressive and toxic (e.g. chloroform, dichlorobenzene, toluene, etc.) [5], [17]. The harsh solvents may not be compatible with certain substrates, such as plastics. In addition, the solvent properties can present post treatment problems, often requiring high temperature post annealing and long drying processes [18]. These issues can limit practical industrial applications. It is desirable to develop GNP functional inks from cheap, non-toxic and environmentally friendly solvents or solvent blends that do not require special post treatments and can be cured at room temperature.
(3) While dispersants such as surfactants and polymers can allow otherwise unsuitable solvents such as water to disperse GNPs [5], [17], the presence of dispersants in the dried film can reduce the electrical performances of GNPs. The high temperature annealing or repeated washing required to remove these dispersants from a dried film limits the range of applications [8].

The present invention has been devised in order to address at least one of the above problems. Preferably, the present invention reduces, ameliorates, avoids or overcomes at least one of the above problems.

Accordingly, in a first preferred aspect, the present invention provides a dispersion of nanoplatelets suspended in a carrier liquid, the nanoplatelets being derived from a layered material, wherein the loading amount of nanoplatelets in the dispersion is at least 20 mg nanoplatelets per 1 ml of dispersion.

In a second preferred aspect, the present invention provides a process of manufacturing a dispersion according to the first aspect, the process including the step of mixing the carrier liquid and the nanoplatelets under high shear conditions.

In a third preferred aspect, the present invention provides a use of a dispersion according to the first aspect as an ink system.

In a fourth preferred aspect, the present invention provides a use of a dispersion according to the first aspect as a functional additive within an ink, coating or adhesive formulation.

In a fifth preferred aspect, the present invention provides a use of a dispersion according to the first aspect in the manufacture of a nanoplatelet-polymer composite, the use including the step of mixing the dispersion with a polymer precursor to form a mixture, and allowing the mixture to solidify.

The first, second, third, fourth and/or fifth aspect of the invention may have any one or, to the extent that they are compatible, any combination of the following optional features.

The present inventors consider that a major contribution provided by the present disclosure is in the development of dispersions having very high loading amounts of nanoplatelets. It is of particular interest that the carrier liquid of the dispersion is or is based on a low-cost, non-toxic and environmentally friendly solvent system.

Preferably, the nanoplatelets are selected from one or more of elemental materials such as graphene (typically derived from pristine graphite), metallics (e.g., NiTe₂, VSe₂), semi-metallics (e.g., WTa₂, TcS₂), semiconductors (e.g., WS₂, WSe₂, MoS₂, MoSe₂, MoTe₂, TaS₂, RhTe₂, PdTe₂), insulators (e.g., h-BN (hexagonal boron nitride), HfS₂), superconductors (e.g., NbS₂, NbSe₂, NbTe₂, TaSe₂) and topological insulators and thermo-electrics (e.g., Bi₂Se₃, Bi₂Te₃). Other materials may be applied as the nanoplatelets.

Preferably, the nanoplatelets have at least one lateral dimension, assessed as a number average, of at least 200 nm. More preferably, the nanoplatelets have at least one lateral dimension, assessed as a number average, of at least 300 nm. Preferably, the nanoplatelets have a footprint area (i.e. the area of one of the larger faces of the nanoplatelets when viewed in plan view), assessed as a number average, of at least 0.1 μm². More preferably, the nanoplatelets have a footprint area of at least 0.5 μm², more preferably at least 1 μm².

The nanoplatelets may be single layer nanoplatelets. However, this is not necessarily essential. The present invention is of particular interest for forming stable dispersions in a cost-effective, environmentally friendly and widely compatible format. Therefore it is intended that it can be readily applied to commercially available nanoplatelets, differing from each other in particle morphology and size distribution. The nanoplatelets may therefore be single layer or few layer. In commercially available products, there is typically a mixture of single layer and few layer nanoplatelets. The thickness distribution of the nanoplatelets may be determined using transmission electron microscopy (TEM) analysis of 20 nanoplatelets selected at random.

The term “single layer” is intended to include a layer which is only a single atom thick, as is the case for elemental layered materials such as graphene formed from graphite. However, where the layered material is a compound, the term “single layer” also includes the thickness of the layer which repeats through the structure of the layered material. In some cases, this thickness may be less than the thickness of the unit cell of the crystal structure, because stacking offsets may cause the unit cell thickness to be two or more times the thickness of the repeating layer.

In some preferred embodiments, the nanoplatelets are graphene nanoplatelets. For example, the graphene nanoplatelets may be derived from pristine graphite. This may be without an oxidation or reduction step, for example. Alternatively, the graphene nanoplatelets may be chemically functionalized and/or intercalated and/or formed by reduction of graphene oxide. Chemical functionalization may for example include the provision of one or more groups selected from —NH₃, —COOH, —OH, —F, ═O, —CH₃.

Preferably, the dispersion is substantially free of dispersant. This is advantageous particularly where it is intended to use the dispersion in a coating or ink. Where a dispersant is included, the dried coating or ink typically includes a dispersant residue. This can deleteriously affect the properties of the coating or ink, particularly where electrical conductivity is of interest. However, in some embodiments, an amount of dispersant may optionally be present. The volume ratio of dispersant to the nanoplatelets should be less than 1:1. Suitable dispersants include: ionic surfactants such as sodium dodecylbenzene sulfonate (SDBS) and sodium deoxycholate (SDC); non-ionic surfactants such as Brij 700 and polysorbate 80 (Tween 80); non-crosslinking polymers such as polyvinylpyrrolidone (PVP) and sodium carboxymethyl cellulose (Na-CMC).

The volume ratio of dispersant to the nanoplatelets is preferably not greater than 0.8:1, more preferably not greater than 0.6:1, more preferably not greater than 0.5:1, more preferably not greater than 0.4:1, more preferably not greater than 0.3:1, more preferably not greater than 0.2:1, more preferably not greater than 0.1:1.

The carrier liquid preferably includes a polar organic solvent as a primary carrier liquid. It may also include a viscosity modifier solvent. It may also include water. A polar organic solvent is of particular interest in view of its miscibility with water and compatibility with water-based systems, or other polar organic solvent-based systems. Preferably, the polar organic solvent has a boiling point not higher than 150° C. at 1 atm.

Preferably, the polar organic solvent has a surface tension, measured at 20° C., of at most 50 mN/m. More preferably, the polar organic solvent has a surface tension, measured at 20° C., of at most 40 mN/m, at most 30 mN/m or at most 25 mN/m. According to the Zisman's empirical equation for wetting of liquids on solid surfaces, a liquid should have a surface tension which is the same as or lower than the surface tension of a solid, in order for the liquid to wet the solid. The present inventors speculate that this applies also in the case of a solvent and a solute, here the solvent being the carrier liquid (or at least the polar organic solvent) and the solute being the nanoplatelets. Taking graphene as an example, the surface energy of graphene is about 70-80 mN/m, which can be converted to surface tension of about 40-50 mN/m. Therefore a solvent with a surface tension of 50 mN/m or lower should be able to wet graphene nanoplatelets and thus can be considered as a polar organic solvent suitable for the development of a suspension of graphene.

In the present disclosure, surface tension may be measured by the pendant drop method.

When present, the viscosity modifier solvent should be miscible with the polar organic solvent. Preferably, the viscosity modifier solvent has a dynamic (shear) viscosity higher than that of the polar organic solvent at 20° C. Thus, preferably the mixture of the polar organic solvent and the viscosity modifier solvent has a higher dynamic viscosity than that of the polar organic solvent alone. Preferably, the viscosity modifier solvent has a dynamic (shear) viscosity at 20° C. of at least 5 mPa·s, more preferably at least 10 mPa·s, more preferably at least 15 mPa·s.

A stable dispersion of the nanoplatelets relies on a balance between gravity (whether negative or positive buoyancy) and the frictional forces experienced by the nanoplatelets during sedimentation. According to Stokes' law, the frictional forces are linearly proportional to the viscosity of the carrier liquid. In this case, any viscosity modifier solvent that is more viscous than and is miscible with the polar organic solvent may be suitable for improving the stability of the dispersion.

Dynamic viscosity may be measured using a rheometer as described in more detail below.

Preferably, the polar organic solvent comprises or consists of one or more alcohols. The surface tension of suitable alcohols, measured at 20° C., is typically lower than 25 mN/m. Additionally, suitable solvents may have relatively low boiling points (typically lower than 100° C.). This assists in the aim to provide a stable solvent and water-compatible nanoplatelet dispersion based on a low-cost, non-toxic and environmentally friendly solvent system, capable of drying quickly under mild drying conditions (e.g. at room temperature).

Preferably, the viscosity modifier solvent comprises or consists of one or more glycols. Glycols typically have high viscosity (typically >15 mPa·s at 20° C.). They are miscible with water and polar organic solvents such as alcohols. They are low-cost, non-toxic and environmentally friendly. As an example, ethylene glycol is particularly suitable.

The mixture of the polar organic solvent and the viscosity modifier solvent may be made before addition of the nanoplatelets. In that case, the surface tension of the mixture is relevant, because it is this surface tension which will determine compatibility with the nanoplatelets by wetting. Thus, preferably the mixture of the polar organic solvent and the viscosity modifier solvent has a surface tension, measured at 20° C., of at most 50 mN/m, 40 mN/m, at most 30 mN/m or at most 25 mN/m.

As an example, ethylene glycol is of interest as a suitable viscosity modifier solvent. This has a surface tension at 20° C. of 48 mN/m.

The carrier liquid may include water. Again, the water may be added to the polar organic solvent and the viscosity modifier solvent before the nanoplatelets, in which case the surface tension of the carrier liquid is relevant, because it is this surface tension which will determine compatibility with the nanoplatelets by wetting. Thus, preferably the carrier liquid has a surface tension, measured at 20° C., of at most 50 mN/m, 40 mN/m, at most 30 mN/m or at most 25 mN/m.

Similarly, the viscosity of the carrier liquid is relevant to the stability of the dispersion. Preferably the carrier liquid has a dynamic (shear) viscosity of at least 1 mPa·s at 20° C.

A particularly preferred carrier liquid consists of ethylene glycol, ethanol and water. The amounts of ethylene glycol:ethanol:water by volume preferably satisfy the ranges defined by 25-35:60-70:1-10. At the time of writing the most preferred carrier liquid consists of ethylene glycol (30%), ethanol (65%) and water (5%) by weight.

The dispersion may include a binder. Suitable binders assist in the adherence of a layer of the nanoplatelets formed by deposition and subsequent drying of the dispersion.

Preferably, the stability of the dispersion is such that, when the dispersion is stored in a container at room temperature (20° C.) substantially without disturbance for 24 hours, an upper portion forms less than 15% of the total volume of the dispersion, wherein the upper portion of the dispersion is defined as having a loading amount of nanoplatelets of less than 20 mg nanoplatelets per 1 ml of dispersion, due to sedimentation.

Preferably, the stability of the dispersion is such that, when the dispersion degrades after storage in a container at room temperature (20° C.) substantially without disturbance for 24 hours, the dispersion can be returned to a homogenous mixture through one or more of agitation, stirring, sonication, etc. Such mixing processes are considered to be mild mixing processes, in that they are easily carried out and do not risk substantial breakage of the nanoplatelets. The dispersion may provide such properties even after storage in a container at room temperature (20° C.) substantially without disturbance for 6 months. The present inventors consider that a homogenous mixture is one such that a sample taken from any depth in the dispersion has the same concentration of dispersed nanoplatelets as a sample taken from any other depth.

Preferably, when the dispersion is stored in a container at room temperature (20° C.) substantially without disturbance for at least 24 hours (or optionally at least 7 days), the amount of sedimentation is less than 15%, wherein the amount of sedimentation is defined with reference to the mass of nanoplatelets in the upper half of the volume of the dispersion in the container, M_{U}, said upper half of the volume of the dispersion in the container being extracted in order to measure the mass of the nanoplatelets, and with reference to the mass of nanoplatelets in the lower half of the volume of the dispersion, including any sediment layer, remaining in the container, M_{L}, the amount of sedimentation in % being the modulus of:

[100×(M_{L}−M_{U})/(M_{L}+M_{U})].

The mass of nanoplatelets in the selected volumes of dispersion can be determined using thermal gravimetric analysis (TGA). This is preferred because typically the dispersion will have too high a concentration for the concentration of nanoplatelets to be assessed by optical absorption for example.

It is possible to centrifuge the dispersion in order to cause sedimentation. The sediment can then be re-dispersed in the carrier liquid using sonication or stirring. This provides a simulation of accelerated aging and subsequent redispersion.

Preferably the loading amount of nanoplatelets in the dispersion is at least 25 mg nanoplatelets per 1 ml of dispersion, more preferably at least 30 mg nanoplatelets per 1 ml of dispersion, more preferably at least 40 mg nanoplatelets per 1 ml of dispersion, more preferably at least 50 mg nanoplatelets per 1 ml of dispersion, more preferably at least 100 mg nanoplatelets per 1 ml of dispersion, more preferably at least 200 mg nanoplatelets per 1 ml of dispersion, more preferably at least 500 mg nanoplatelets per 1 ml of dispersion.

High loadings of nanoplatelets per unit volume of dispersion is made easier using high shear mixing of the nanoplatelets in the carrier liquid. Where there is a high loading, the dispersion will have high viscosity. For this reason, simple liquid-based mixing techniques such as sonication, stirring or agitation may not be feasible. High shear can be achieved by blade mixers, blenders or equivalent systems, impeller systems (high velocity hydraulic shear through a mixer screen), homogenizers (high pressure shear mixing through narrow channels). See, for example, the disclosure of high shear rotor/stator systems at http://www.silverson.co.uk/en/products/laboratorv-mixers/how-it-works (accessed 14 Jul. 2015). See also the disclosure of homogenizers at http://www.microfluidicscorp.com/our-technolow/how-it-works (accessed 14 Jul. 2015).

In the use of the dispersion in the manufacture of a composite, the polymer precursor may be one or more of: a molten polymer; a monomer, oligomer or pre-polymer or a solution of a monomer, oligomer or pre-polymer; a polymer solution. In this way, the polymer precursor may be provided in liquid form. This allows the dispersion to be mixed with the polymer precursor in a straightforward manner to ensure a homogeneous mixture. Preferably, in the case where the dispersion is added to the polymer precursor, the polymer precursor itself is miscible with the carrier liquid.

The polymer precursor may for example be the polymer itself (e.g. in granulated form). In this case, preferably the polymer is capable of dissolving in the carrier liquid.

The inventors have additionally found that the approach used and outlined above for nanoplatelets may have broader applicability. Specifically, the dispersion may be formed using particles derived from a layered material, where the particles need not necessarily be nanoplatelets. This is considered to be an independent aspect of the present invention.

Preferably, the particles derived from a layered material have at least one lateral dimension, assessed as a number average, of greater than 300 nm. Preferably, these particles derived from a layered material have at least one lateral dimension, assessed as a number average, of less than 30 μm, more preferably not more than 20 μm. Preferably, the particles have a footprint area (i.e. the area of one of the larger faces of the material when viewed in plan view), assessed as a number average, of less than 500 μm², more preferably not more than 400 μm².

The inventors have found that stable dispersions of such particles are possible using the carrier liquids defined above.

Further optional features of the invention are set out below.

### BRIEF DESCRIPTION OF THE DRAWINGS

Embodiments of the invention will now be described by way of example with reference to the accompanying drawings in which:

FIG. 1 shows the sheet resistance of a printed layer formed from GNP sample G3 in a dispersion according to an embodiment of the invention, including a binder.

FIG. 2 shows the effect on the contact angle (surface tension) of an ink formulation based on the addition of different amounts of a graphene pre-dispersion according to an embodiment of the invention to the ink formulation.

FIGS. 3A-3D show the effect on the viscosity measured at different shear rates for the ink formulation and graphene pre-dispersion combination reported in FIG. 2.

FIG. 4 shows the effect on the sheet resistance where a GNP pre-dispersion is added to a commercially available carbon ink. (a) Sheet resistance vs graphene content. (b) Percentage reduction in sheet resistance vs commercial ink.

FIG. 5 shows the resistivity of G3-PVA composites according to embodiments of the invention. The inset shows an image of the composite film.

FIG. 6 shows a graph of the time-dependent absorbance at 550 nm of MoS₂ dispersions reported in Table 3.

FIG. 7 shows a graph of the time-dependent absorbance at 550 nm of the h-BN dispersions reported in Table 4.

FIG. 8 shows a graph of the time-dependent absorbance at 550 nm of the graphite dispersions reported in Example 6.

### DETAILED DESCRIPTION OF THE PREFERRED EMBODIMENTS, AND FURTHER OPTIONAL FEATURES OF THE INVENTION

The preferred embodiments of the present invention relate to mass production of dispersant/binder free graphene pre-dispersions by mixing graphene nanoplatelets (GNPs, consisting of single and few-layer graphene) from a variety of sources into an inexpensive, non-toxic and environmentally friendly, low temperature processable solvent system. In the most preferred embodiment at the time of writing, the solvent system consists of only ethylene glycol, ethanol and water.

The term “dispersions” includes pre-dispersions. In the relevant technical field, pre-dispersions are understood as being dispersions which are intended to be added into or combined with other components. In preferred embodiments of the present invention, the other components are components of ink systems, adhesive formulations or polymer formulations.

The pre-dispersions of the preferred embodiments of the present invention can be used as functional additives to existing formulations of ink systems (such as carbon black, graphite ink etc.), adhesive systems and/or composite systems to enhance their electrical, thermal or mechanical properties suitable for a wide range of functional printing and coating techniques (including, but not limited to flexo-, gravure-, screen-, offset-printing, doctor blade-, web- and spray-coating) and suitable for various substrates (paper, polymer, glass, etc.).

GNP dispersions according to the preferred embodiments of the present invention preferably contain no dispersants. The dispersion can either itself be independently used as an ink system or can be used as an additive, or pre-dispersion.

For embodiments of the present invention where the dispersion includes one or more dispersants, preferably the volume ratio of dispersant to the nanoplatelets is less than 1:1. Suitable dispersants include: ionic surfactants such as sodium dodecylbenzene sulfonate (SDBS) and sodium deoxycholate (SDC); non-ionic surfactants such as Brij 700 and polysorbate 80 (Tween 80); non-crosslinking polymers such as polyvinylpyrrolidone (PVP) and sodium carboxymethyl cellulose (Na-CMC).

GNP composites comprise GNPs embedded in a matrix such as a polymer. Polymer-GNP composites can be formed by producing a homogeneous fluent mixture of GNPs and polymers/polymer precursors [19]-[23]. GNPs can be directly mixed into molten polymers (e.g. thermoplastics). However, melting typically requires high temperature, and achieving a fine mixing (to provide a suitably homogenous distribution of GNPs in the resultant polymer-GNP composite) in this case can be challenging, especially when the loading of GNPs is high. It is therefore preferable to produce the mixture by blending GNPs or a GNP pre-dispersion with a polymer solution or precursor. This leads to many of the same issues discussed above for ink formulation—namely that the solvents available for GNP dispersion are usually harsh organic solvents, creating challenges in drying or curing the mixtures to form composites, while the presence of the dispersants required in aqueous dispersions can reduce the performances of the final composites. Therefore, it is desirable to use a non-toxic, dispersant-free and low boiling point GNP pre-dispersion to introduce GNPs into composites.

To overcome these challenges, the present inventors have developed an inexpensive, non-toxic and environmentally friendly, low temperature solvent system, which is subsequently used to stably disperse commercially available GNPs to receive large quantities of dispersant/binder free GNP pre-dispersions. The solvent system of the most preferred embodiment at the time of writing consists of only ethylene glycol, ethanol, and water, and is developed in such a manner that the ratio of three solvent compositions is tuned to control the solvent system properties such as viscosity and surface tension. The GNP pre-dispersions can be used as functional inks with/without addition of binders. Addition of a binder in some circumstances may be preferred, since a binder typically operates to assist the dried ink to adhere to a substrate. Controlling the ratio of the solvent compositions and the loading of GNPs allows good control of the properties such as viscosity of the GNP functional inks, meaning that the inks are suited for a wide range of functional printing and coating techniques on various rigid, conformable and flexible substrates. Furthermore, the printed GNP patterns do not need high temperature annealing, long drying process, or other special post treatments. Meanwhile, the compatibility of this solvent system with water and ethanol allows the GNP pre-dispersions to work as additives to water and ethanol based functional ink and composite systems so as to enhance their electrical, thermal or mechanical properties.

Techniques for production of GNPs are known, even in large quantities. Furthermore, it is known to develop GNP-based functional inks and composites. These methods start with production of GNPs. B. Jang, et al. proposed various indirect methods to produce GNPs in large quantities. Generally, the first step is to prepare appropriate graphene precursors, either from graphite powders of appropriate dimensions [12] or from heat-treated polymers [10]. The second step is to exfoliate the graphene precursors into graphene platelets by gas cracking [10], intercalation [10], [11], [21] or chemical treatments [10]. Additional processing steps such as sonication [21] or attrition such as ball milling [10] can be used to further exfoliate the GNPs. The produced GNPs can be pristine, or chemically functionalized, and they may contain impurities such as intercalants involved in the preparation process. The GNPs are in dry powder status or dispersed in liquids.

GNPs dispersed in liquids are subsequently formulated into functional inks. The investigation on the interaction of GNPs and solvents reveal that GNPs are best dissolved in expensive, aggressive and toxic organic solvents, such as chloroform, benzene, toluene, etc. [5], [17]. Published patent applications such as [5] and [17] present methods relating to formulating GNP functional inks, primarily for inkjet printing. In these methods, the GNP inks may further comprise binders to aid adhesion between the printed GNPs and the substrate, composite polymers to achieve printed GNP-polymer composites, and conducting elements such as CNTs and PEDOT:PSS to enhance electrical or thermal properties. However, it is not clear whether these GNP functional inks are suitable for other existing printing and coating deposition techniques, or what types of substrates the inks are compatible with. It is also not disclosed whether the inks require special post treatments.

GNP-polymer composites may be produced from a fluent mixture of GNPs and polymers/polymer precursors [19]-[23]. Mixing is typically by mixing GNPs into molten polymers, by mixing polymers/polymer precursors into GNP dispersions, or by blending GNP dispersions with polymer dispersions or polymer precursors. The mixtures are then consolidated or polymerized through cooling, curing, annealing, or evaporating, etc. to form a solid composite. These composites can be shaped into specific shapes such as filaments and fibres by extruding. Patents such as [20] and [21] relate to preparation of composites by polymerisation of a mixture of GNPs and polymer precursor. Ref [19] discloses a method of extruding GNP composite filaments and fibres, giving aligned GNPs in the composite.

The preferred embodiments of the present invention allow the manufacture of graphene pre-dispersions in large quantities. These can work as functional inks, as additives to other ink systems, and as additives to composite systems. More specifically, the pre-dispersions comprise (1) commercial GNPs, optionally from various sources, preferably consisting of single and few-layer graphene and (2) a solvent system that consists of ethylene glycol, alcohol and water, of which the three solvent components are cheap, non-toxic and relatively environmentally friendly. The GNPs can be mixed into the solvent system at a high loading through stirring at room temperature. Mixing can be further assisted by mechanical or shear mixing (such as, but not limited to ultrasonication, single/multi-stage hydraulic shear, high pressure homogenization through microchannels, high speed blade/screen assisted mixing) etc. This forms stable GNP pre-dispersions without the need for additional dispersants. The GNP pre-dispersions can work as functional inks. By tuning the ratio of the solvent compositions and the loading of GNPs to allow control of the pre-dispersion properties such as viscosity, the GNP functional inks can be made suitable for various functional printing and coating techniques on a range of rigid, conformable and flexible substrates.

As mentioned above, for embodiments of the present invention where the dispersion includes one or more dispersants, preferably the volume ratio of dispersant to the nanoplatelets is less than 1:1. Suitable dispersants include: ionic surfactants such as sodium dodecylbenzene sulfonate (SDBS) and sodium deoxycholate (SDC); non-ionic surfactants such as Brij 700 and polysorbate 80 (Tween 80); non-crosslinking polymers such as polyvinylpyrrolidone (PVP) and sodium carboxymethyl cellulose (Na-CMC).

The printed GNP patterns do not need high temperature post annealing. Preferably, they can be processed at room temperature. Additionally, preferably they do not require long drying processes or other special post treatments. As the GNP dispersions are compatible with water and widely-used solvents, the GNP pre-dispersions can be used as additives to water and solvent based functional inks to enhance their properties.

Meanwhile, the GNP pre-dispersions can also be used as additives for water and solvent based/dissolvable composite systems for a range of applications, including electrically and thermally conductive plastics, conductive adhesives, and electrodes for energy storage applications.

Mass production of GNPs is usually separated in three steps: (1) prepare appropriate graphene precursors which is done by either choosing graphite powders of appropriate sizes (at least one dimension is below 200 μm, can be achieved through attrition such as ball milling of larger graphite crystals) or carbonizing carbon polymers through heat treatments or by plasma-enhanced cracking of carbon feedstock gases; (2) exfoliate the graphene precursors into graphene platelets by gas cracking, intercalation and chemical treatments, etc.; (3) further exfoliate the separated graphene platelets by sonication or attrition such as ball milling. The resultant GNPs are either in dry powder status or dispersed in liquids.

In the previously-known approach, the GNPs are dispersed in solvents to form GNP dispersions. The solvents used here are typically expensive, harsh, and toxic organic solvents. This is because thorough investigations of the solvents reveal these solvents are suitable for GNPs. Alternatively, the GNPs are dispersed in aqueous dispersions which require dispersants such as suitable surfactants and polymers. As mentioned above, for embodiments of the present invention where the dispersion includes one or more dispersants, preferably the volume ratio of dispersant to the nanoplatelets is less than 1:1. Suitable dispersants include: ionic surfactants such as sodium dodecylbenzene sulfonate (SDBS) and sodium deoxycholate (SDC); non-ionic surfactants such as Brij 700 and polysorbate 80 (Tween 80); non-crosslinking polymers such as polyvinylpyrrolidone (PVP) and sodium carboxymethyl cellulose (Na-CMC).

In previous work, GNP functional inks, preferably for inkjet printing, were formulated from the GNP dispersions with/without the addition of binders. The inks can further comprise composite polymers, conducting elements, etc.

In previous work, mixtures of GNPs and polymer/polymer precursors are prepared through mixing GNPs into molten polymers, through mixing polymers/polymer precursors into GNP dispersions, or through blending GNP dispersions with polymer dispersions or polymer precursors. Solid GNP-polymer composites are formed by consolidation or polymerization of the mixtures through cooling, curing, annealing, or evaporating, etc. These composites can be molded into specific shapes such as filaments and fibres.

In the preferred embodiment of the present invention, ethylene glycol, ethanol and water are mixed and stirred to develop a homogeneous solvent system, in which the ethanol takes a large proportion so that the solvent system has a high wettability to GNPs, and of which the ratio of the three solvents are tuned to control the solvent system properties such as viscosity. This solvent system is the liquid carrier for GNPs.

The process is applicable to a wide range of different GNP powders, as demonstrated by the examples below using 4 powders from 2 different suppliers.

The low boiling point and low toxicity of the solvents, and the broad tunability of pre-dispersion properties such as viscosity allows the pre-dispersions to be used as inks for established printing techniques such as spray coating, flexography, gravure printing and screen printing, without modification of such techniques. An example is demonstrated below in which the electrical properties of the GNP conducting inks are investigated.

The miscibility of the pre-dispersion solvents allows inks to be formulated with the addition of polymer binders to aid robustness of the printed film. An example is demonstrated below where inks are prepared through the addition of water soluble binders.

The GNP pre-dispersions can be used as additives for a wide range of water and solvent based conductive functional inks to enhance their conductivity. An example is demonstrated below on the improvements of electrical performance of a commercial carbon based flexographic ink with the addition of a GNP pre-dispersion according to an embodiment of the present invention.

The GNP pre-dispersions can be used as additives for a wide range of water and solvent based composites. An example is demonstrated below by developing GNP-PVA composites through drying a mixture of the GNP pre-dispersions and aqueous PVA.

In the preferred embodiments of the present invention, a dispersion according to an embodiment of the invention is mixed with a polymer precursor to form a mixture, and the mixture is allowed to solidify. The polymer precursor may be the polymer itself (e.g. in granulated form), where the polymer is capable of dissolving in the carrier liquid of the dispersion. Alternatively the polymer precursor may be: a molten polymer; a monomer, oligomer or pre-polymer; or a polymer solution.

GNP pre-dispersions are prepared by dispersing commercial GNPs into a solvent system of ethylene glycol, ethanol and water through stirring. Techniques such as sonication, milling and various shear mixing methods are employed to assist and promote the mixing process. The GNP pre-dispersions can directly be used as functional, conductive inks (Example 1), as additives to other functional inks to significantly improve their conductivity (Example 2), and as additives to composites to introduce conductivity of the otherwise insulating polymers/adhesives (Example 3).

### EXAMPLE 1

In this Example, the GNP pre-dispersions are used as functional inks with/without the addition of binders. Four types of commercial GNPs are investigated and are referred here as G1, G2, G3 and G4.

G1 and G2 were sourced from Cambridge Nanosystems[http://cambridgenanosystems.com/]. The product designations of these materials at Cambridge Nanosystems are G2 (for the material referred to here as G1) and G3 (for the material referred to here as G2).

G3 and G4 were sourced from Perpetuus Advanced Materials [http://perpetuusam.com/]. The product designations of these materials at Perpetuus Advanced Materials are NGP30 (for the material referred to here as G3) and SDP 30 (for the material referred to here as G4).

The typical solvent compositions used in this example is 30:65:5 (ethylene glycol:ethanol:water) by wt. %. GNPs are added into the solvent system and the mixture is sonicated at low power for about 30 mins to disassociate any large GNP aggregates. The mixture is then stirred for about 12 hours to achieve a homogeneous and stable dispersion. In the examples presented here, up to 25% loadings of the GNPs are achieved by simple mixing (loading is expressed as weight GNPs per unit volume dispersion (i.e. GNPs plus liquid carrier).

Higher loading of up to 75% is possible. This is achieved using high shear mixing. This tends to produce high viscosity pastes rather than the liquid inks used for the following characterisation techniques.

In the measurements reported below, the GNP loadings are G1-2 wt %, G2-3 wt %, G3-25 wt %, G4-25 wt %. The inventors have found that the pre-dispersions remain stable for at least one month when stored undisturbed at room temperature.

The viscosity of the four pre-dispersions is presented in Table 1. The viscosity is measured using a 40 mm diameter stainless steel parallel plate rheometer (TA Instruments Discovery HR-1). The shear rate is stepped from 5 s⁻¹ to 1000 s⁻¹, allowing the change of viscosity with shear to be measured. The viscosity is assumed to be pseudoplastic (i.e. the liquid behaves as a viscous fluid for all rates of shear, with decreasing effective viscosity for increasing shear). This can be modelled by a power law, with relationship:

η_{eff,σ}=Kσⁿ⁻¹

where K (Pa·s) is the consistency index (equivalent to the viscosity if the fluid is Newtonian), σ (s⁻¹) is the shear rate, n is the dimensionless flow index, and η_{eff,σ} (Pa·s) is the viscosity at shear rate σ [24]. Table 1 shows the K and n values for the four pre-dispersions. For reference, the calculated viscosities for selected shear rates in typical ranges for printing are also shown:

TABLE 1
Viscosity of the GNP predispersions

| | K | | η_{eff, 1} | η_{eff, 10} | η_{eff, 100} | η_{eff, 1000} | η_{eff, 10000} |
|---|---|---|---|---|---|---|---|
| GNP | (Pa · s) | n | (mPa · s) | (mPa · s) | (mPa · s) | (mPa · s) | (mPa · s) |
| G1 | 1.07 | 0.45 | 1070 | 304 | 86.1 | 24.4 | 6.91 |
| G2 | 2.10 | 0.37 | 2100 | 494 | 116 | 27.3 | 6.41 |
| G3 | 1.93 | 0.47 | 1930 | 562 | 164 | 47.9 | 14.0 |
| G4 | 5.49 | 0.28 | 5490 | 1040 | 196 | 37.2 | 7.03 |

This indicates that the pre-dispersions are suitable for working as the functional inks without any binder for deposition techniques such as drop casting, spray coating, doctor blading, rod-coating, flexogravure- or offset-printing, etc.

G1, G2, G3 and G4 pre-dispersions were investigated as conducting inks without addition of binders. Drop casting and blade coating onto paper substrate was used to quickly study their electrical properties. The samples were baked at 50° C. for 10 mins. The typical sheet resistances were about 4 kΩ/□, about 4.5 kΩ/□, about 40Ω/□, and about 300Ω/□, respectively. G3 formed the most conductive conducting ink among these four commercial GNPs. We also exploited blade coating to deposit G3 ink, giving a sheet resistance of G3 pattern on glass of about 40 Ω/□.

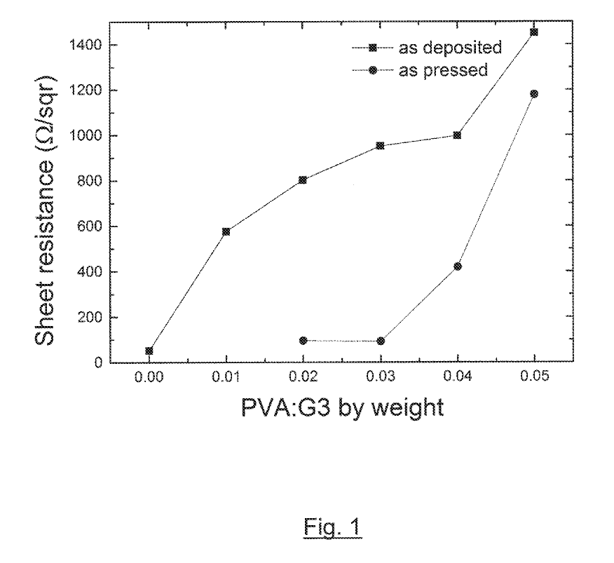

The pre-dispersions were further investigated as conducting inks with the addition of polymer binders. For this, we used G3 (about 40 DIE without binder) to illustrate the electrical behaviour when a binder is introduced. We used polyvinyl alcohol (PVA), a water-soluble polymer, as the example. The weight ratio of PVA to graphene was varied from 0.01:1 to 0.05:1. The change in sheet resistance with respect to graphene is presented as the “as deposited” curve in FIG. 1. This shows an increase of sheet resistance with the increasing PVA content. Since the dried patterns are of a porous structure, we made use of pressing to decrease the inter distance between graphene nanoplatelets and investigate its electrical behaviour, which is as shown in the “as pressed” curve in FIG. 1. Pressing gives a sheet resistance of about 90Ω/□ for ratio 0.02 and 0.03. However, pressing damages the ratio 0 and 0.01 patterns such that their sheet resistances are not measurable, while the other patterns remain undamaged and firm. G3-PVA (at ratio of 0.03) ink was also deposited on glass by blade coating, and the as pressed sheet resistance also goes down to about 90Ω/□. We have further investigated other polymers as the binder, such as carboxymethyl cellulose (CMC). G3-CMC shows a similar electrical behaviour.

This example indicates that 1) binders can typically increase mechanical performance of dried GNP patterns though decrease the conductivity; 2) there is a very large potential that when well-developed binder systems are used, GNP-binder can retain the high conductivity of GNPs while achieving a good mechanical performance.

### EXAMPLE 2

In this Example, GNP pre-dispersions were used as an additive for a carbon based ink to enhance the conductivity. This is demonstrated with a G3 pre-dispersion prepared as described in Example 1. The G3 pre-dispersion is added to a commercial carbon ink [of Novalia Ltd., [http://www.novalia.co.uk/] having properties similar to Gwent C2080529P7 flexographic ink [http://www.gwent.org/gem_data_sheets/polymer_systems_products/flexographic_inks/carbon_c2080529p7.pdf] in ratios from about 2 to about 15 wt. %.

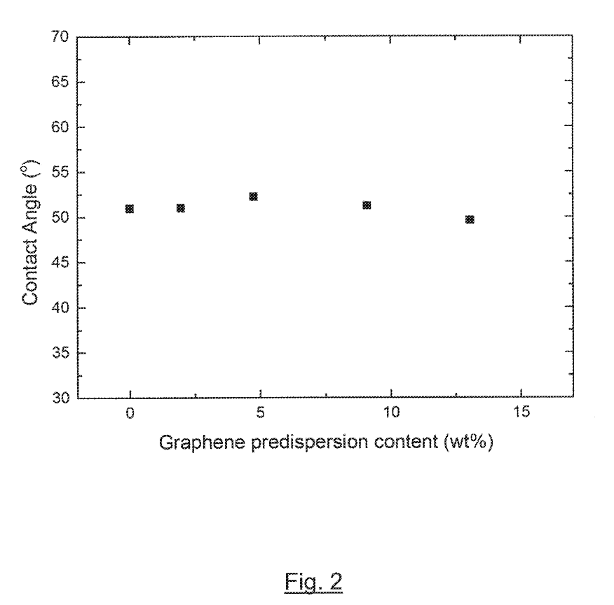

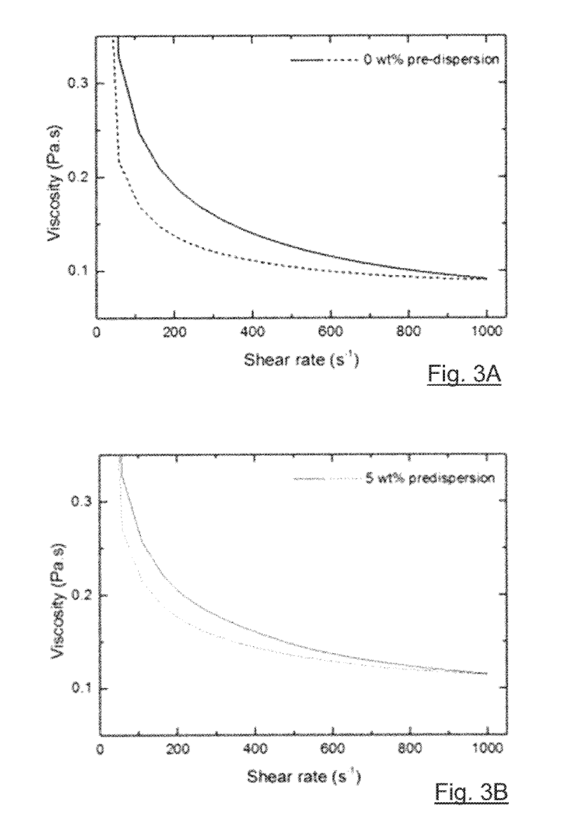

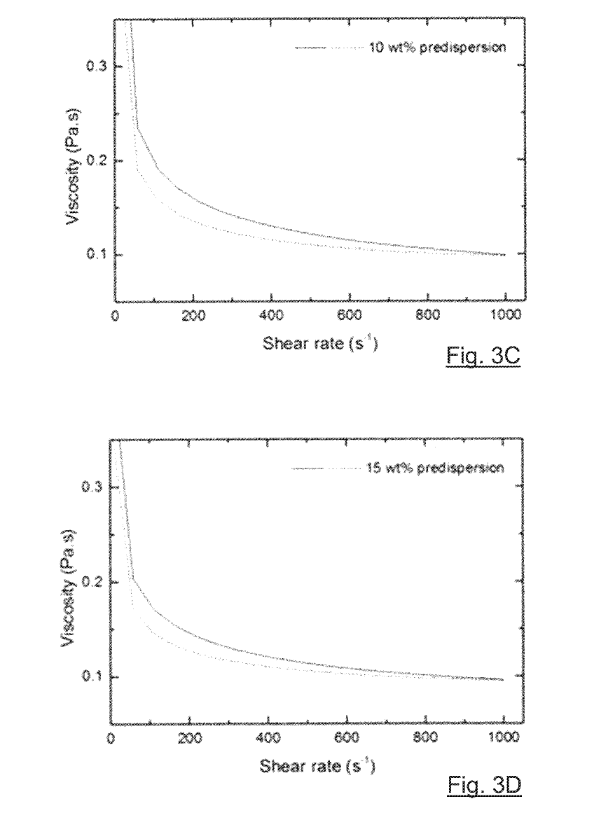

In order to be effective, an additive for addition to an ink should enhance the performance of the ink while not affecting its printability. The contact angle (surface tension) and viscosity of an ink are two key parameters that will determine how it will behave within the printing system. Therefore the G3 pre-dispersion was added to the commercial carbon ink at different addition amounts, and the contact angle measured (FIG. 2) and the viscosity measured at different shear rates (FIG. 3).

The surface tension was measured by depositing a suitable droplet of each ink ratio on a glass substrate at room temperature. It should be noted here that the key is consistency of the contact angle for different additive ratios, rather than the specific number. As can be seen from FIG. 2, the variation is <3% for all levels of additive within the range.

The effect on viscosity was measured according to a similar protocol to Example 1, in which the viscosity was measured under conditions of gradually increasing shear rate (solid lines in FIG. 3). Additionally, viscosity was subsequently measured under conditions of gradually decreasing shear rate (dashed lines in FIG. 3). As with the pre-dispersions, the ink undergoes shear thinning. However, due to the binder system used with the commercial ink, there are also time-dependent effects (i.e. the ink does not recover its viscosity immediately). This is apparent from the viscosity curves in FIG. 3, which show reduced viscosity during the decreasing shear measurements (dashed lines) compared to the increasing shear (solid lines). Overall, it is judged that the effect of the additives on the viscosity is small across the range of shear, and the printability of the modified ink is not substantially affected.

Test films on PET and paper were prepared by a rod-coating (K2 bar; wet thickness of 12 μm) method. The sheet resistance of these test films was measured. The results are reported in Table 2.

TABLE 2
values of sheet resistance for rod coated samples of commercial
ink with range of graphene content on PET and paper.

| Sub- | Addi- | Additive amount | Sheet resistance | Change |
|---|---|---|---|---|
| strate | tive | (wt %) | (kΩ/□) | (% reduction) |
| PET | none | — | 1.23 | — |
| PET | G3 | 2.4 | 1.11 | 9 |
| PET | G3 | 4.8 | 0.96 | 21 |
| PET | G3 | 9 | 0.85 | 31 |
| PET | G3 | 13 | 0.81 | 34 |
| Paper | none | — | 2.18 | — |
| Paper | G3 | 2.4 | 1.69 | 23 |
| Paper | G3 | 4.8 | 1.25 | 43 |
| Paper | G3 | 9 | 0.93 | 57 |
| Paper | G3 | 13 | 0.93 | 57 |

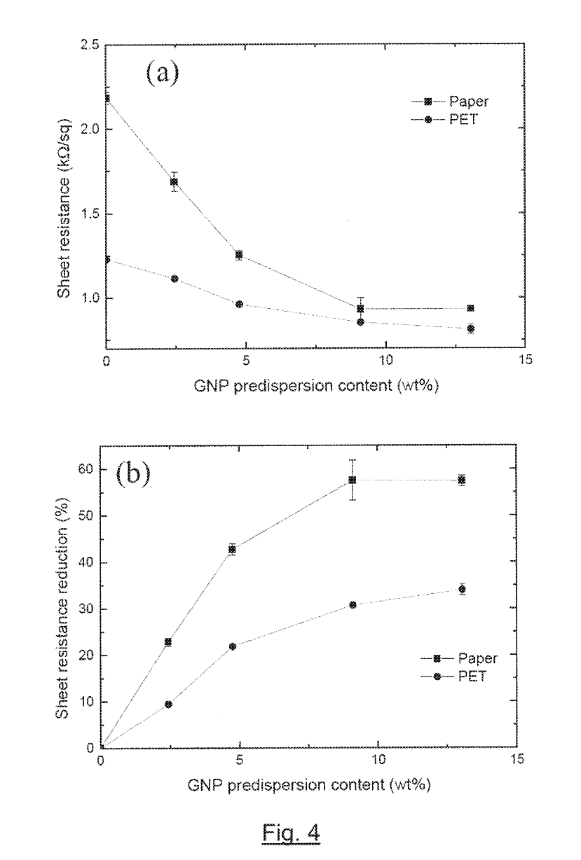

The effect on sheet resistance of the graphene additive is shown in FIG. 4. As can be seen from FIG. 4(b), 10% w/w of GNP additive into the commercial ink is sufficient to reduce the sheet resistance by about 30% on PET, and about 60% on paper.

### EXAMPLE 3

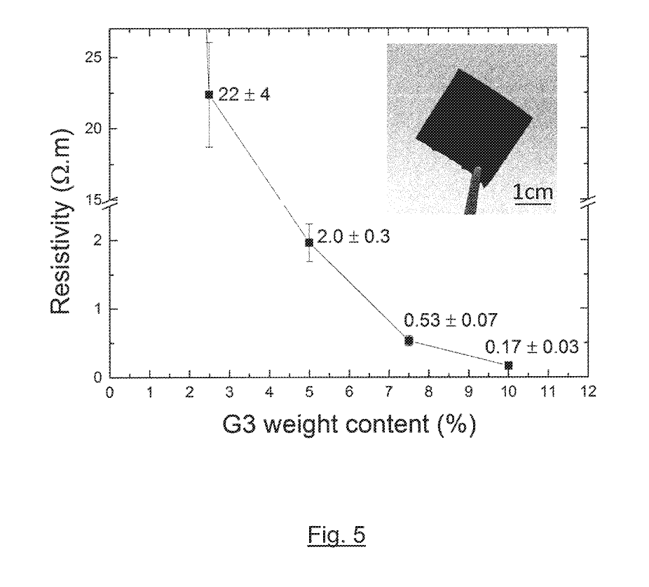

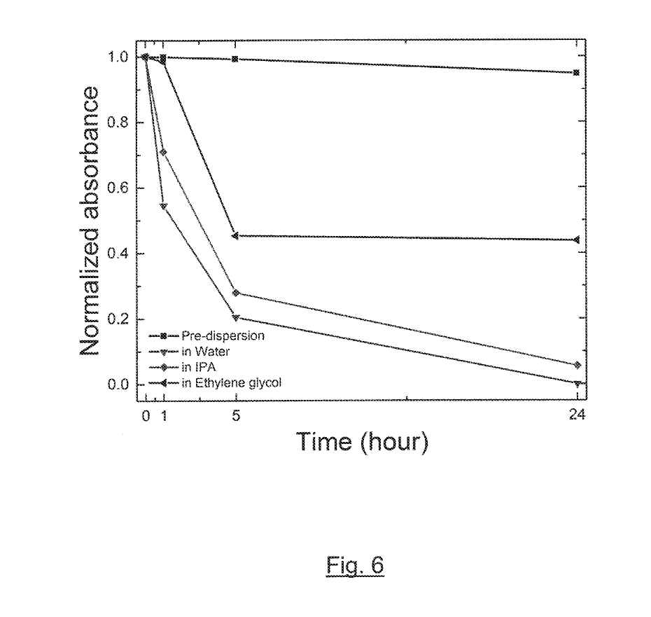

This Example uses the GNP pre-dispersions as electrically conductive fillers in a polymer composite. This is demonstrated with a G3 pre-dispersion prepared as described in Example 1. The G3 pre-dispersion was homogeneously mixed with an aqueous solution of PVA and dried to produce free-standing composite films with graphene filler proportions ranging from 2.5-10 w/w %. The high solid content of the G3 pre-dispersion (25 wt. %) means that only small volumes of the dispersion need to be added to the PVA solution to achieve the requisite fill factor. The resistivity of the four materials is shown in FIG. 5, and it can be seen that even low filler proportions can introduce significant electrical conductivity into the composite to be used as an adhesive.

### EXAMPLE 4

This Example demonstrates the applicability of the present invention to materials other than graphene. It also demonstrates the applicability of the invention to forming stable dispersions of particles, rather than nanoplatelets. It is readily apparent that this Example can be modified to use nanoplatelets of the same composition, with the same or improved results.

In this Example, three comparative samples and one embodiment sample were prepared. Bulk MoS₂ crystals were directly dispersed into (i) pure distilled water, (ii) pure isopropyl alcohol (IPA), (iii) pure ethylene glycol and (iv) a carrier liquid mixture consisting of isopropyl alcohol (IPA), ethylene glycol and water. The solvent composition used in this embodiment sample was 50:20:30 (IPA:ethylene glycol:water) by wt. %.

Bulk MoS₂ crystals (Sigma, average particle size about 6 μm) was added into the solvent system at a loading of 3 wt. %. [It is observed that loadings of up to 80 wt. % are possible.] The mixtures were then stirred and sonicated for 60 hours to achieve a homogeneous and stable dispersion in all the liquids, where possible.

The time-dependent stability of the samples was assessed from images taken of the samples at 0, 1, 5 and 24 hours after the dispersions were prepared. This is reported in Table 3, below.

TABLE 3
Time-dependent stability of MoS₂ particles in different carrier liquids

| Sample | 0 hour | 1 hour | 5 hours | 24 hours |
|---|---|---|---|---|
| (i) MoS₂ in | turbid suspension | sediment and | sediment and | sediment and |
| water | with flocculant | flocculant | flocculant | flocculant |
| (ii) MoS₂ in | homogeneous | layered | layered | complete |
| IPA | dispersion | separation | separation and | sedimentation |
| | | observable | sedimentation | |
| (iii) MoS₂ in | homogeneous | nearly | layered | layered |
| EG | dispersion | homogeneous | separation | separation and |
| | | dispersion | observable | sedimentation |
| (iv) MoS₂ in | homogeneous | homogeneous | homogeneous | homogeneous |
| IPA + ethylene | dispersion | dispersion | dispersion | dispersion |
| glycol + water | | | | |

After 24 hours, obvious sedimentation was observed for the samples in which the carrier liquid included only a single component. In sample (i) prepared using pure water, a turbid suspension was observed with obvious flocculants floating to the meniscus of the liquid. A high degree of layered separation could be observed in samples (ii) and (iii).

Only in sample (iv), which is an embodiment of the invention, did the dispersion show no signs of separation. This confirms the dispersion stability.

FIG. 6 illustrates the time-dependent absorbance at 550 nm of the MoS₂ dispersions reported in Table 3. The absorbance is normalized to the initial absorbance value. The relative straight line of the predispersion (sample (iv) in Table 3) over 24 hours depicts overall stability of the predispersion as compared to the pure solvent-based samples.

### EXAMPLE 5

In this Example, three comparative samples and one embodiment sample were prepared. Bulk h-BN crystals were directly dispersed into (i) pure distilled water, (ii) pure isopropyl alcohol (IPA), (iii) pure ethylene glycol and (iv) a carrier liquid mixture consisting of isopropyl alcohol (IPA), ethylene glycol and water. The solvent composition used in this embodiment sample was 50:20:30 (IPA:ethylene glycol:water) by wt. %.

Bulk h-BN crystals (Sigma, average particle size about 1 μm) was added into the solvent system at a loading of 3 wt. %. [It is observed that loadings of up to 30 wt. % are possible.] The mixtures were then stirred and sonicated for 60 hours to achieve a homogeneous and stable dispersion in all the liquids, where possible.

The time-dependent stability of the samples was assessed from images taken of the samples at 0, 1, 5 and 24 hours after the dispersions were prepared. This is reported in Table 4, below.

TABLE 4
Time-dependent stability of h-BN particles in different carrier liquids

| Sample | 0 hour | 1 hour | 5 hours | 24 hours |
|---|---|---|---|---|
| (i) h-BN in | flocculant | sediment and | sediment and | sediment and |
| water | | flocculant | flocculant | flocculant |
| (ii) h-BN in | homogeneous | layered | layered | complete |
| IPA | dispersion | separation | separation and | sedimentation |
| | | observable | sedimentation | |
| (iii) h-BN in | homogeneous | nearly | layered | layered |
| EG | dispersion | homogeneous | separation | separation and |
| | | dispersion | observable | sedimentation |
| (iv) h-BN in | homogeneous | homogeneous | homogeneous | homogeneous |
| IPA + ethylene | dispersion | dispersion | dispersion | dispersion |
| glycol + water | | | | |

After 24 hours, obvious sedimentation was observed for the samples in which the carrier liquid included only a single component. In sample (i) prepared using pure water, obvious flocculants could be observed through the glass wall of the container within the carrier liquid. A high degree of layered separation was observed in samples (ii) and (iii).

Only in sample (iv), which is an embodiment of the invention, did the dispersion show no signs of separation. This confirms the dispersion stability.

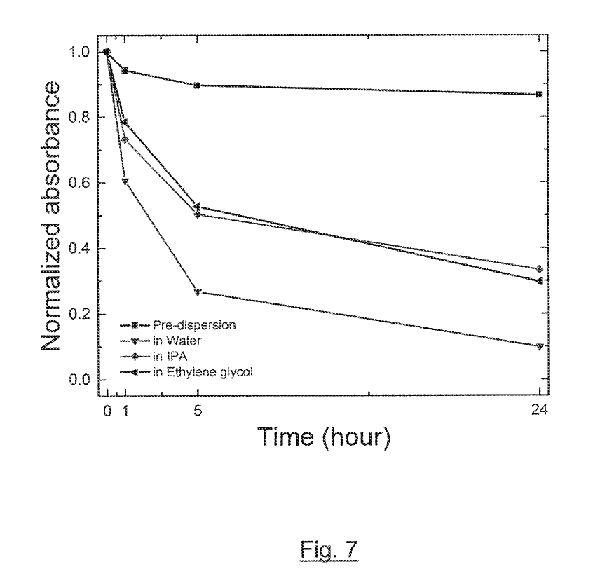

FIG. 7 illustrates time-dependent absorbance at 550 nm of the h-BN dispersions reported in Table 4. The absorbance is normalized to the initial absorbance value. The relative straight line of the predispersion (sample (iv) in Table 4) over 24 hours depicts overall stability of the predispersion as compared to the pure solvent-based samples.

### EXAMPLE 6

In this Example, two comparative samples and one embodiment sample were prepared. Graphite crystals were directly dispersed into (i) pure isopropyl alcohol (IPA), (ii) pure ethylene glycol and (iii) a carrier liquid mixture consisting of isopropyl alcohol (IPA) and ethylene glycol. The solvent composition used in this embodiment sample was 90:10 (IPA:ethylene glycol) by wt. %.

Bulk graphite (Sigma, average particle size about 20 μm) was added into the solvent system at a loading of 10 wt. %. [It is observed that loadings of up to 80 wt. % are possible.] The mixtures were then stirred and sonicated for 100 hours to achieve a homogeneous and stable dispersion of graphene in all the liquids, where possible.

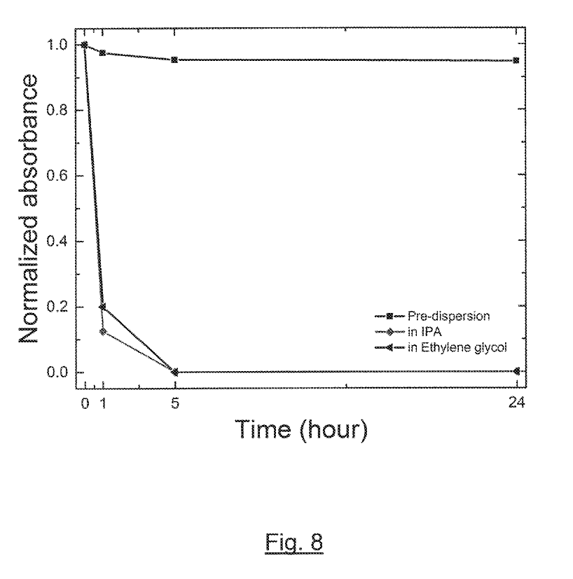

FIG. 8 illustrates time-dependent absorbance at 550 nm of the graphene dispersions. The absorbance is normalized to the respective initial absorbance value. The relative straight line of the predispersion (sample (iii)) over 24 hours depicts overall stability of the predispersion as compared to the pure solvent mixtures (samples (i) and (ii)).

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above and/or below are hereby incorporated by reference.

### REFERENCES

[1] E. B. Secor and M. C. Hersam, “Emerging Carbon and Post-Carbon Nanomaterial Inks for Printed Electronics,” J. Phys. Chem. Lett., vol. 6, no. 4, pp. 620-626, 2015.
[2] E. T. Thostenson, Z. Ren, and T.-W. Chou, “Advances in the science and technology of carbon nanotubes and their composites: a review,” Compos. Sci. Technol., vol. 61, no. 13, pp. 1899-1912, 2001.
[3] S. Chand, “Carbon fibers for composites,” J. Mater. Sci., vol. 35, no. 6, pp. 1303-1313, 2000.
[4] Y. Liu and S. Kumar, “Polymer/carbon nanotube nano composite fibers-A review,” ACS Appl. Mater. Interfaces, vol. 6, no. 9, pp. 6069-6087, 2014.
[5] B. Z. Jang and A. Zhamu, “Nano graphene platelet-based conductive inks and printing process.” US 2012/0007913.
[6] J.-H. Chen, M. Ishigami, C. Jang, D. R. Hines, M. S. Fuhrer, and E. D. Williams, “Printed Graphene Circuits,” Adv. Mater., vol. 19, no. 21, pp. 3623-3627, November 2007.
[7] F. Torrisi, T. Hasan, W. Wu, Z. Sun, A. Lombardo, T. S. Kulmala, G.-W. Hsieh, S. Jung, F. Bonaccorso, P. J. Paul, D. Chu, and A. C. Ferrari, “Inkjet-Printed Graphene Electronics,” ACS Nano, vol. 6, no. 4, pp. 2992-3006, 2012.
[8] “Graphene Inks for Printed Electronics I Sigma-Aldrich.” [Online]. Available: http://www.sigmaaldrich.com/technical-documents/articles/technology-spotlights/graphene-inks-for-printedelectronics.html. [Accessed: 24 May 2015].
[9] S. Stankovich, D. a Dikin, G. H. B. Dommett, K. M. Kohlhaas, E. J. Zimney, E. a Stach, R. D. Piner, S. T. Nguyen, and R. S. Ruoff, “Graphene-based composite materials.,” Nature, vol. 442, no. 7100, pp. 282-6, July 2006.
[10] B. Z. Jang and W. C. Huang, “Nano-scaled graphene plates.” U.S. Pat. No. 7,071,258.
[11] B. Z. Jang, A. Zhamu, and J. Guo, “Mass production of nano-scaled platelets and products.” US 2010/0222482.
[12] B. Jang, L. Yang, S. C. Wong, and Y. Bai, “Process for producing nano-scaled graphene plates.” US 2005/0271574.
[13] A. Zhamu and B. Z. Jang, “Method of producing nano-scaled inorganic platelets.” U.S. Pat. No. 8,308,984.
[14] A. Zhamu and B. Z. Jang, “One-step production of graphene materials.” U.S. Pat. No. 8,747,623.
[15] A. Zhamu, J. Shi, J. Guo, and B. Z. Jang, “Method of producing exfoliated graphite, flexible graphite, and nanoscaled graphene platelets.” U.S. Pat. No. 7,824,651.
[16] A. Zhamu, J. Shi, J. Jang, and B. Z. Jang, “Method for producing ultra-thin nano-scaled graphene platelets.” U.S. Pat. No. 8,883,114.
[17] B. Z. Jang and A. Zhamu, “Nano graphene platelet-based conductive inks.” US 2010/0000441.
[18] M. Lotya, Y. Hernandez, P. J. King, R. J. Smith, V. Nicolosi, L. S. Karlsson, F. M. Blighe, S. De, Z. Wang, I. T. McGovern, G. S. Duesberg, and J. N. Coleman, “Liquid phase production of graphene by exfoliation of graphite in surfactant/water solutions.,” J. Am. Chem. Soc., vol. 131, no. 10, pp. 3611-20, March 2009.
[19] J. Guo, L. Song, A. Zhamu, and B. Z. Jang, “Nano-scaled graphene plate-reinforced composite materials and method of producing same.” US 2010/0092723.
[20] B. Z. Jang, A. Zhamu, and J. Guo, “Process for producing nano-scaled platelets and nanocompsites.” U.S. Pat. No. 7,875,219.
[21] B. Z. Jang and A. Zhamu, “Method of producing nano-scaled graphene and inorganic platelets and their nanocomposites.” U.S. Pat. No. 8,114,373.
[22] B. Z. Jang, A. Zhamu, J. Guo, and L. Song, “Hybrid fiber tows containing both nano-fillers and continuous fibers, hybrid composites, and their production processes.” US 2008/0020193.
[23] B. Z. Jang, A. Zhamu, and L. Song, “Highly conductive composites for fuel cell flow field plates and bipolar plates.” U.S. Pat. No. 8,865,040.
[24] Paint and coating testing manual, J. V. Koleske (ed) ASTM International, 1995.

1. A dispersion of nanoplatelets or particles suspended in a carrier liquid, the nanoplatelets or particles being derived from a layered material, wherein the loading amount of nanoplatelets or particles in the dispersion is at least 20 mg nanoplatelets or particles per 1 ml of dispersion, the dispersion optionally further including a dispersant, the volume ratio of dispersant to the nanoplatelets or particles being less than 1:1.

2. The dispersion according to claim 1 wherein the nanoplatelets or particles are selected from one or more of: elemental materials, metallics, semi-metallics, semiconductors, insulators, superconductors, topological insulators, and thermo-electrics.

3. The dispersion according to claim 1 wherein the nanoplatelets are graphene nanoplatelets.

4. The dispersion according to claim 3 wherein the graphene nanoplatelets are derived from pristine graphite without an oxidation or reduction step.

5. The dispersion according to claim 3 wherein the graphene nanoplatelets are at least one of: chemically functionalized, intercalated, and formed by reduction of graphene oxide.

6. The dispersion according to claim 5 wherein the chemical functionalization comprises one or more of the groups including but NH3, —COOH, —OH, —F, ═O, and —CH3.

7. The dispersion according to claim 1 being substantially free of dispersant.

8. The dispersion according to claim 1 wherein the carrier liquid comprises a polar organic solvent as a primary carrier liquid having a boiling point not higher than 150° C. at 1 atm.

9. The dispersion according to claim 8 wherein the polar organic solvent has a surface tension, measured at 20° C., of at most 50 mN/m.

10. The dispersion according to claim 8 wherein the polar organic solvent has a surface tension, measured at 20° C., of at most 30 mN/m.

11. The dispersion according to claim 8 comprising a viscosity modifier solvent and wherein the viscosity modifier solvent is miscible with and has a dynamic (shear) viscosity higher than that of the polar organic solvent at 20° C.

12. The dispersion according to claim 8 wherein the polar organic solvent comprises one or more alcohols.

13. The dispersion according to claim 11 wherein the viscosity modifier solvent comprises one or more glycols.

14. The dispersion according to claim 8 further comprising water.

15. The dispersion according to claim 1 wherein the carrier liquid consists of ethylene glycol, ethanol and water.

16. The dispersion according to claim 15 wherein the amounts of ethylene glycol:ethanol:water by weight satisfy the ranges defined by 25-35:60-70:1-10.

17. The dispersion according to claim 1 wherein the carrier liquid has a surface tension of at most 50 mN/m at 20° C.

18. The dispersion according to claim 1 wherein the carrier liquid has a dynamic (shear) viscosity of at least 1 mPa·s at 20° C.

19. The dispersion according to claim 1 wherein the stability of the dispersion is such that, when the dispersion is stored in a container at room temperature (20° C.) substantially without disturbance for 24 hours, an upper portion forms less than 15% of the total volume of the dispersion, wherein the upper portion of the dispersion is defined as having a loading amount of nanoplatelets or particles of less than 20 mg nanoplatelets or particles per 1 ml of dispersion, due to sedimentation.

20. The dispersion according to claim 1 wherein the stability of the dispersion is such that, when the dispersion degrades after storage in a container at room temperature (20° C.) substantially without disturbance for 24 hours, the dispersion can be returned to a homogenous mixture through one or more of agitation, stirring, sonication.

21. The dispersion according to claim 1 wherein the stability of the dispersion is such that, when the dispersion degrades after storage in a container at room temperature (20° C.) substantially without disturbance for 6 months, the dispersion can be returned to a homogenous mixture through one or more of agitation, stirring, sonication.

22. The dispersion according to claim 1 wherein the stability of the dispersion is such that, when the dispersion is stored in a container at room temperature (20° C.) substantially without disturbance for at least 7 days, the amount of sedimentation is less than 15%, wherein the amount of sedimentation is defined with reference to the mass of nanoplatelets or particles in the upper half of the volume of the dispersion in the container, MU, said upper half of the volume of the dispersion in the container being extracted in order to measure the mass of the nanoplatelets or particles, and with reference to the mass of nanoplatelets or particles in the lower half of the volume of the dispersion, including any sediment layer, remaining in the container, ML, the amount of sedimentation in % being the modulus of: [100×(ML−MU)/(ML+MU)]

23. A process of manufacturing a dispersion of nanoplatelets or particles suspended in a carrier liquid, the nanoplatelets or particles being derived from a layered material, wherein the loading amount of nanoplatelets or particles in the dispersion is at least 20 mg nanoplatelets or particles per 1 ml of dispersion, the dispersion optionally further including a dispersant, the volume ratio of dispersant to the nanoplatelets or particles being less than 1:1, the process including the step of mixing the carrier liquid and the nanoplatelets or particles under high shear conditions.

24. An ink system comprising a dispersion of nanoplatelets or particles suspended in a carrier liquid, the nanoplatelets or particles being derived from a layered material, wherein the loading amount of nanoplatelets or particles in the dispersion is at least 20 mg nanoplatelets or particles per 1 ml of dispersion, the dispersion optionally further including a dispersant, the volume ratio of dispersant to the nanoplatelets or particles being less than 1:1.

25. An ink, coating or adhesive formulation comprising a functional additive comprising a dispersion of nanoplatelets or particles suspended in a carrier liquid, the nanoplatelets or particles being derived from a layered material, wherein the loading amount of nanoplatelets or particles in the dispersion is at least 20 mg nanoplatelets or particles per 1 ml of dispersion, the dispersion optionally further including a dispersant, the volume ratio of dispersant to the nanoplatelets or particles being less than 1:1.

26. A method for the manufacture of a nanoplatelet-polymer composite or a particle-polymer composite, the method including the step of mixing a dispersion with a polymer precursor to form a mixture, and allowing the mixture to solidify, wherein the dispersion is a dispersion of nanoplatelets or particles suspended in a carrier liquid, the nanoplatelets or particles being derived from a layered material, wherein the loading amount of nanoplatelets or particles in the dispersion is at least 20 mg nanoplatelets or particles per 1 ml of dispersion, the dispersion optionally further including a dispersant, the volume ratio of dispersant to the nanoplatelets or particles being less than 1:1.

27. The method according to claim 26 wherein the polymer precursor is one or more of: a molten polymer; a monomer, oligomer or pre-polymer; a polymer solution.

28. The method according to claim 26 wherein the dispersion is added to said polymer precursor, wherein the polymer precursor itself is miscible with the carrier liquid.

29. The method according to claim 26 wherein the polymer precursor is dissolved directly in the carrier liquid of the dispersion.
